(19) United States
(12) Patent Application Publication
(10) Pub. No.: US 2007/0264376 A1
(43) Pub. Date: Nov. 15, 2007

(54) Jig for baking ceramic honeycomb moldings

(75) Inventor: Kazuya Souda, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya City (JP)

(21) Appl. No.: 11/783,672

(22) Filed: Apr. 11, 2007

(30) Foreign Application Priority Data
May 15, 2006 (JP) 2006-135449

(51) Int. Cl. B25B 11/00

(52) U.S. Cl. 425/110

(57) ABSTRACT

In a baking jig 1 for holding a ceramic honeycomb molding 3 having a large number of cells 31 juxtaposed with one another in an axial direction, an upper surface 21 coming into contact with the ceramic honeycomb molding 3 has a concavo-convex shape and one of the end faces 32 of the ceramic honeycomb molding 3 is supported by a large number of parallel convex portions 21. Recess portions 22 formed between the large number of convex portions 21 constitute ventilation passages 4 communicating with outside, and at least 30% of cells among cells 31 of the ceramic honeycomb molding 3 opening to the one end face 32 communicate with the ventilation passages 4 so that a decomposition gas occurring inside can be diffused from a bottom portion.

### BACKGROUND OF THE INVENTION

1. Field of the Invention

This invention relates to a jig for baking a molding, having a honeycomb structure, that is used for a ceramic support for an exhaust gas purification catalyst and for a ceramic filter for collecting fine exhaust particulate matters.

2. Description of the Related Art

A ceramic honeycomb structure has been used in the past as a support of an exhaust gas purification catalyst arranged in an exhaust passage of a car engine and a filter substrate material of a Diesel particulate filter. The ceramic honeycomb structure is generally produced by the steps of forming a body by adding a binder, a dispersant, water, etc, to ceramic raw material powder, kneading the resulting mixture to obtain the body, extruding the body from an extrusion mold having grid grooves into a honeycomb molding having a predetermined shape, and drying and baking the honeycomb molding.

To bake the ceramic honeycomb molding, a ceramic plate made of ceramic, as shown in FIG. 4C, is generally used as a baking jig 1′ and baking is carried out while the molding 3 is put on the flat surface of the baking jig 1′. Japanese Unexamined Patent Publication No. 6-281359 is one of the prior art references relating to the baking jig. The reference discloses the construction in which fine concavo-convexities (2,000 to 1,500 nm, for example) on the surface of the baking jig keeping contact with the molding by coating treatment or blast treatment, and is used as a placing portion of the molding such as a ceramic device.

However, the following problems are yet to be solved regarding the baking of ceramic honeycomb moldings. Water of crystallization contained in ceramic raw material and organic matters such as a binder and a dispersant scatter as a decomposition gas in the heating process during baking. When the decomposition gas does not quickly diffuse but stays inside the cells of the ceramic honeycomb molding, the temperature of the honeycomb structure becomes non-uniform and cracks are likely to occur owing to a stress resulting from the temperature difference.

The decomposition gas cannot easily diffuse at the contact surface between the ceramic honeycomb molding and the baking jig, in particular, because the cell openings of the ceramic honeycomb molding are closed. This also holds true of the baking jig disclosed in Japanese Unexamined Patent Publication No. 6-281359 having the placing surface that is formed by the surface treatment, and the temperature difference cannot be eliminated easily. As a result, the strength of the honeycomb structure cannot withstand the stress resulting from the temperature difference and cracks occur in the baked body. To avoid this problem, it is necessary to control the temperature elevation rate to suppress the temperature rise, and to conduct baking while the diffusion of the decomposition gas is promoted. Consequently, the baking time becomes longer and productivity drops.

### SUMMARY OF THE INVENTION

It is therefore an object of the present invention to improve a jig for baking a ceramic honeycomb molding to achieve smooth diffusion of a decomposition gas occurring inside a honeycomb structure at the time of baking, to prevent the occurrence of cracks due to stress resulting from a temperature difference and, eventually, to shorten the baking time and to efficiently produce high quality ceramic honeycomb moldings with high productivity.

According to one aspect of the invention for accomplishing the objects described above, there is provided a jig for placing and baking a ceramic honeycomb molding having a large number of cells juxtaposed with one another in an axial direction, wherein a surface coming into contact with the ceramic honeycomb molding has a concavo-convex shape, one of the end faces of the ceramic honeycomb molding is supported by a large number of convex portions of the surface, recess portions formed between pairs of the large number of convex portions form ventilation passages communicating with outside, and at lest 30% or more of cells among cells of the ceramic honeycomb molding opening to the one end face communicate with the ventilation passages.

When the ceramic honeycomb molding is baked, water of crystallization contained in the ceramic raw material and organic matters such as a binder, a dispersant, etc, that are added at the time of molding scatter as a decomposition gas in a predetermined temperature range. This decomposition gas occurs at all portions of the ceramic honeycomb molding. The reaction heat occurs when the decomposition gas scatters, and results in the occurrence of a temperature difference inside the honeycomb structure. Because the temperature difference is proportional to the quantity of the resulting gas, it is preferred to diffuse the decomposition gas as soon as possible without allowing it to stay inside the cells.

According to the construction of the present invention, the ventilation passage communicating with the outside is formed between the surface of the baking jig and the bottom surface of the ceramic honeycomb molding and at least 30% or more of cells are released to the ventilation passages. Therefore, the decomposition gas diffuses from the bottom portion of the ceramic honeycomb molding through the ventilation passage and the temperature of the honeycomb structure is prevented from becoming non-uniform. The invention thus makes it possible to prevent the occurrence of cracks owing to the stress that results from the temperature difference, to improve the quality of the baked body obtained and to improve the productivity by shortening the baking time.

In the jig for baking the ceramic honeycomb molding according to the invention, 50% to 70% of cells of the ceramic honeycomb molding which open to the one end face communicate with the ventilation passage.

Appropriately, when 50% or more of the cells are open to the ventilation passage, diffusion of the decomposition gas is promoted and the effect of preventing the occurrence of cracks owing to the temperature difference can be improved. To satisfy supporting of the ceramic honeycomb molding and prevention of the cracks, the proportion of the cells is preferably 70% or below and, in such a case, the quality and the productivity of the baked body can be improved.

In the jig for baking the ceramic honeycomb molding according to the invention, the surface having the concavo-convex shape is a corrugated shape.

More concretely, the surface keeping contact with the ceramic honeycomb molding can be a corrugated shape, the molding can be supported on the convex portions extending in parallel with one another with predetermined gaps among them and the recess portions extending in parallel with one another with predetermined gaps can be used as ventilation passages to the outside.

In the jig for baking the ceramic honeycomb molding according to the invention, the surface having the concavo-convex shape has a shape having a large number of projection portions.

Alternatively, it is possible to employ the construction in which a large number of projections are disposed with predetermined gaps on the surface coming into contact with the ceramic honeycomb molding to form convex portions, the molding is supported by the tops of the convex portions and the space between the projections to serve as the recess portions are used as ventilation passages to the outside.

In the jig for baking the ceramic honeycomb molding according to the invention, the height of the convex portions supporting one of the end faces of the ceramic honeycomb molding has a height of at least 2 mm or more.

When the height of the convex portion is appropriately at least 2 mm or more, sufficient space to operate as a ventilation passage can be formed between pairs of the convex portions and diffusion of the decomposition gas can be promoted.

In the jig for baking the ceramic honeycomb molding according to the invention, the pitch gap of the convex portions described above is 5 mm to 30 mm.

When the pitch gap of the convex portions is appropriately from 5 mm to 30 mm, sufficient space to serve as a ventilation passage can be formed between pairs of the convex portions and the ceramic honeycomb molding can be supported while diffusion of the decomposition gas is promoted.

The present invention may be more fully understood from the description of preferred embodiments of the invention, as set for the below, together with the accompanying drawings.

### BRIEF DESCRIPTION OF THE DRAWINGS

In the drawings:

FIG. 1A shows a structure of a jig for baking a ceramic honeycomb molding having a corrugated shape according to a first embodiment of the present invention;

FIG. 1B shows a structure of a jig for baking a ceramic honeycomb molding having a projection shape according to a second embodiment of the present invention;

FIG. 2 is an explanatory view for explaining a contact surface structure of the baking jig having the corrugation shape and the jig for baking the ceramic honeycomb molding in the first embodiment;

FIG. 3 is a schematic view showing a ceramic honeycomb molding structure and is useful for explaining the occurrence of a decomposition gas during baking;

FIG. 4A is a perspective view showing the state where the ceramic honeycomb molding is placed on the baking jig having the corrugated shape in the first embodiment of the invention;

FIG. 4B is a perspective view showing the state where the ceramic honeycomb molding is placed on the baking jig having the projection shape in the second embodiment of the invention;

FIG. 4C is a perspective view showing the state where a ceramic honeycomb molding is placed on a baking jig according to the prior art;

FIG. 5 is a partial enlarged perspective view showing a construction of a jig for baking a ceramic honeycomb molding having a corrugated shape that is used in the embodiment of the invention;

FIG. 6 is a partial enlarged perspective view showing a construction of a jig for baking a ceramic honeycomb molding having a projected shape that is used in the embodiment of the invention;

FIG. 7 is an explanatory view useful for explaining a judgment method of the occurrence of cracks on an end face in the embodiments of the invention; and

FIG. 8 is an explanatory view useful for explaining a judgment method of the occurrence of cracks on a side surface in the embodiments of the invention.

### DESCRIPTION OF THE PREFERRED EMBODIMENTS

The present invention will be explained in detail with reference to the accompanying drawings. The baking jig according to the invention is a jig used for placing and baking a ceramic honeycomb molding and has a good diffusion performance, for a decomposition gas, by stipulating the shape of the contact surface of the jig and cells communicating with outside in a predetermined ratio.

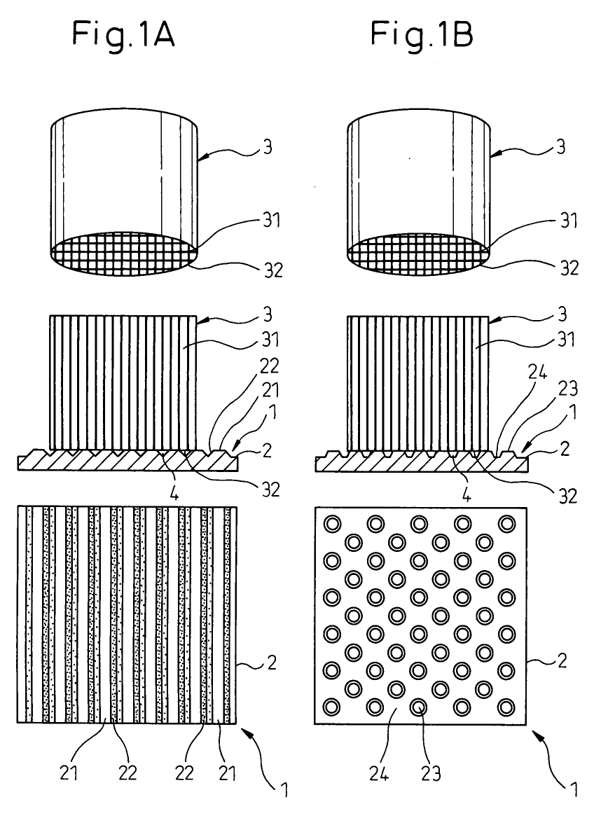

In the first embodiment of the invention shown in FIG. 1A, the baking jig 1 for the ceramic honeycomb molding consists of sheet-like ceramic body that has a predetermined thickness and is shaped into a size sufficiently larger than the ceramic honeycomb molding 3. An upper surface 2 on which the ceramic honeycomb molding 3 is placed is shaped into a corrugation shape and has on its entire surface a large number of convex portions 21 that extend in parallel with one another with predetermined gaps among them and have a trapezoidal sectional shape. A large number of recess portions 22, that extend in parallel with one another with predetermined gaps among them and have an inverted triangular sectional shape, are formed among a large number of convex portions 21.

The ceramic honeycomb molding 3 has a structure in which a large number of cells 31 are juxtaposed in an axial direction inside a cylindrical outer cylinder, and one of the end faces (bottom face in the drawing) 32, to which a large number of cells 31 are open, is supported on and by a large number of convex portions 21 disposed on the upper surface 2 of the baking jig 1. At this time, spaces are formed between a large number of recess portions 22 and the end face 32 on the upper surface 2 and constitute ventilation passages 4 communicating with the outside. The decomposition gas inside the cells 31 can be diffused from the side of the one end face 32 to the outside because the ventilation passages 4 are formed.

The base material of the ceramic body that constitutes the jig 1 for baking the ceramic honeycomb molding is not particularly limited and ordinary materials can be used. Concrete examples include cordierite, mullite, alumina and silicon carbide, and a suitable material may be selected in accordance with the kind of the ceramic honeycomb molding 3 and its baking condition.

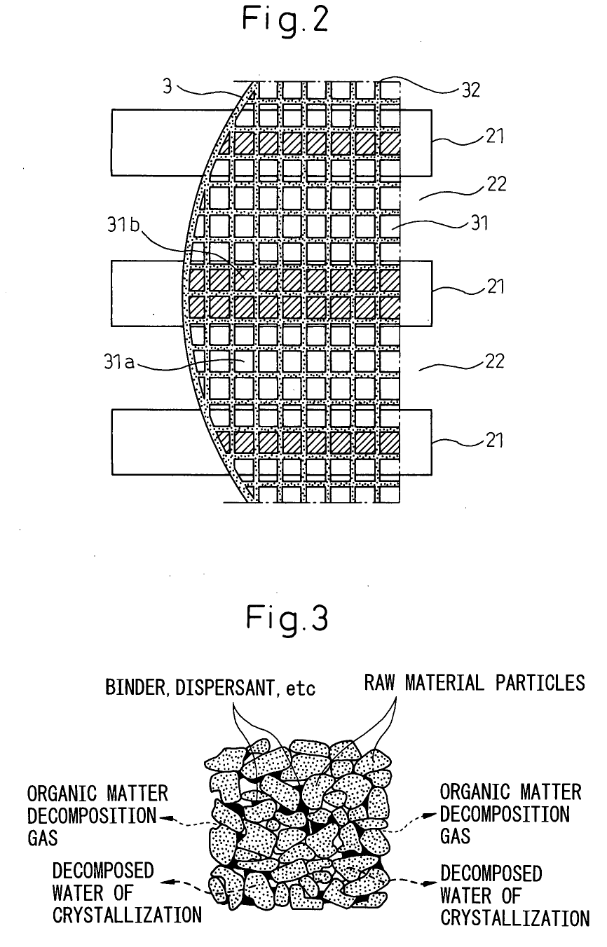

FIG. 2 is a partial enlarged view showing a contact state between the upper surface 2 of the baking jig 1 and the one end face 32 of the ceramic honeycomb molding 3. As shown in this drawing, the entire surface of the cell open ends of a part of cells 31b among a large number of cells 31 on the one end face 32 is closed by the convex portions 21 of the upper surface 2 and does not communicate with the outside. A part of the cell open end or the entire surface of the other cells 31a opposes the recess portions 22 of the upper surface 2 and communicates with the outside through the ventilation passage 4 defined with the one end surface 32. Therefore, the decomposition gas inside the cells 1a opening to the ventilation passage 4 is diffused also from the bottom surface side to the outside.

In the invention, these numerous cells 31 are constituted in such a manner that at least 30% or more of the cells are the cells 31a that communicate with the ventilation passage 4, that is, in such a manner that the cell open end is not completely closed on the side of the one end face 32 and at least a part or the entire surface opposes the recess portions 22. Because at least 30% or more of the cells 31 are released to the ventilation passages 4, the decomposition gas inside the cells 31 is quickly diffused to thereby suppress the occurrence of the temperature difference in the honeycomb structure.

Preferably, at least 50% or more of the numerous cells 31 are the cells 31a communicating with the ventilation passage 4 and, according to this construction, the decomposition gas can be dissipated from the top and the bottom of the ceramic honeycomb molding 3 and the temperature of the honeycomb structure is prevented from becoming non-uniform. However, the effect does not change even when the percentage exceeds 70% and support of the ceramic honeycomb structure becomes likely to be insufficient. Therefore, the percentage is preferably within the range of 50% to 70%.

Incidentally, FIG. 2 shows a so-called “monolithic molding”, that is, the shape in which all of the large number of cells 31 are open on one end face 32 of the ceramic honeycomb molding 3. When the present invention is applied to baking of a filter substrate of a Diesel particulate filter (DPF), however, a large number of cells 31 are alternately sealed on the one end face 32 of the ceramic honeycomb molding 3. In this case, the cells 31 at least a part or the entire surface of which opposes the recess portion 22 and communicates with the ventilation passage 4 among the cells 31 having the opening on the one end face 32 may be so constituted as to achieve the predetermined ratio described above.

The shape of the jig 1 for baking the ceramic honeycomb molding may be such that a large number of projection portions 23 are disposed with predetermined gaps on the upper surface 2 as shown in FIG. 1B as the second embodiment of the invention. These projection portions 23 have a substantially conical shape the top of which is flat, for example, and the space formed between recess portions 24 arranged between adjacent pairs of the large number of projection portions 23 and the one end face 23 constitute a ventilation passage 4 communicating with the outside.

As described above, the shape of the upper surface 2 of the baking jig 1 of the ceramic honeycomb molding may be such that it has a large number of concavo-convexities on the entire surface, the one end face 32 of the ceramic honeycomb molding 3 is supported on the large number of projection portions while the recess portions defined between the large number of projection portions constitute the ventilation passage 4 communicating with the outside. In either shape, a similar effect can be obtained by constituting the ceramic honeycomb structure so that a predetermined ratio or more of cells 31 among the large number of cells 31 communicates with the ventilation passage 4.

The height of the projection portions supporting the one end face 32 of the ceramic honeycomb molding 3 is preferably 2 mm or more. When the height of the large number of projection portions is 2 mm or more, the sufficient space can be formed between the projection portions, diffusion of the decomposition gas from the ventilation passage 4 to the outside is promoted and the occurrence of the cracks can be prevented.

The pitch gap of the large number of projection portions is preferably from 5 mm to 30 mm. When the pitch gap of the large number of projection portions is 5 mm or more, the sufficient space to serve as the ventilation passage 4 can be formed between the projection portions. However, even when the pitch gap is increased to a level greater than 30 mm, the effect does not much change and recessing is likely to occur, on the contrary, because the load concentrates on the projection portion.

The ceramic honeycomb molding 3 baked by using the jig 1 for baking the ceramic honeycomb molding is acquired by the steps of extrusion molding a body prepared by blending and mixing a binder, a dispersant, a lubricant and water as molding assistants in a predetermined ratio with ceramic raw material powder and kneading the mixture, into a honeycomb shape, by using a known extrusion molding machine. The ceramic raw material is not particularly limited and various ceramic materials such as oxides, nitrides, carbides, and the like, typified by cordierite, alumina, silica, titania, silicon nitride and silicon carbide can be used.

The molding thus extrusion molded is further dried into a ceramic honeycomb molding 3 by using a known radio frequency dryer or a known hot air dryer. While the resulting molding is placed on the jig 1 for baking the ceramic honeycomb molding 3, it is baked inside a baking furnace to obtain the baked body having a honeycomb structure.

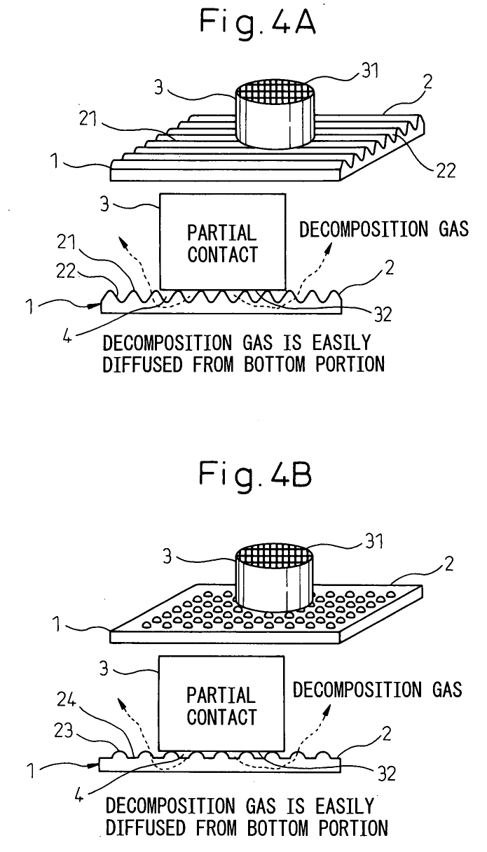

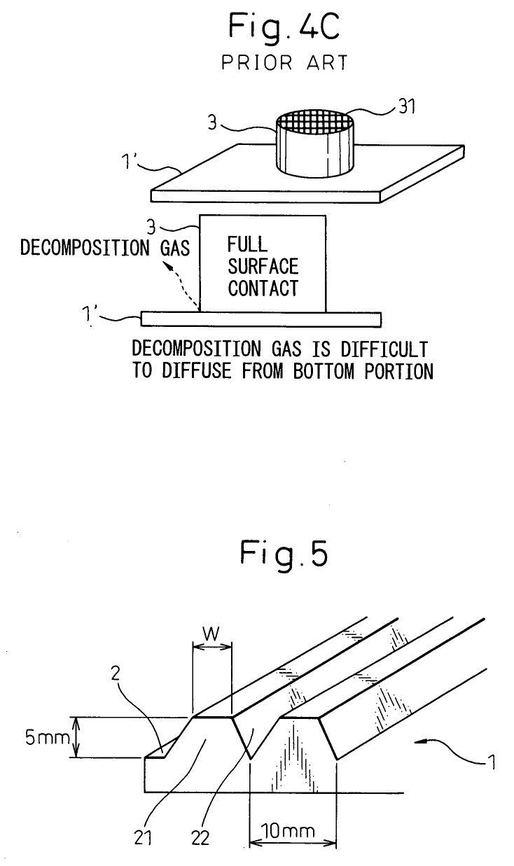

During the baking process of the ceramic honeycomb molding 3, water of crystallization and the organic materials such as the binder, the dispersant, etc, added at the time of molding are decomposed in predetermined temperature ranges with the increase in temperature as shown in FIG. 3. This decomposition gas occurs at all portions of the ceramic honeycomb molding and the reaction heat occurs when the decomposition gas scatters. Therefore, if the decomposition gas remains inside the cells, a temperature difference is likely to occur in the honeycomb structure. In the baking jig 1′ according to the prior art shown in FIG. 4C, the support surface is a flat surface and the bottom surface of the ceramic honeycomb molding 3 and the surface of the baking jig 1′ comes into full surface contact, so that the decomposition gas cannot easily diffuse from the bottom portion. In consequence, the decomposition gas remains, a temperature difference occurs in the honeycomb structure and cracks due to the stress occur.

When the baking jig 1 according to the invention shown in FIGS. 4A and 4B is used, in contrast, the upper surface 2 having the concavo-convex shape and the bottom surface of the ceramic honeycomb molding 3 come into partial contact. The recess portions 22 and 24 formed between pairs of the large number of convex portions 21 or the projection portions 23 operate as the ventilation passage 4 and communicate the inside of the cells 31 with the outside. Consequently, the decomposition gas can more easily diffuse from the bottom portion, the occurrence of the cracks owning to the stress resulting from the temperature difference inside the honeycomb structure can be prevented, and the baking time can be shortened to thereby improve the production factor.

### EXAMPLES

Next, concrete Examples and Comparative Examples will be given to confirm the effect of the invention.

### Examples 1 to 5, Comparative Examples 1 to 3

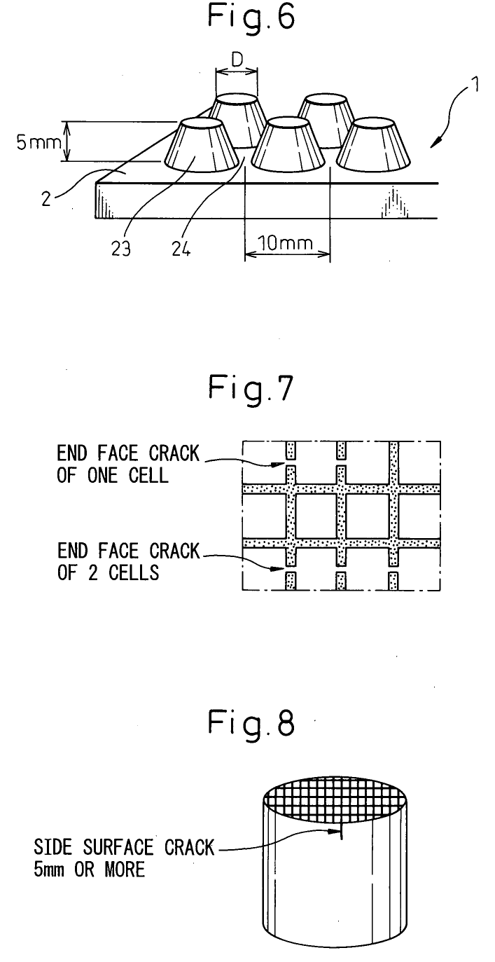

Baking of the ceramic honeycomb moldings 3 formed of cordierite was carried out by respectively using ceramic honeycomb molding baking jigs 1 having a corrugation shape shown in FIG. 1A and a projection shape shown in FIG. 1B. The baking jig 1 having the corrugation shape had convex portions 21 formed on an upper surface 2 of a ceramic body having a sheet thickness of 9 mm. The convex portion 21 had a height of 5 mm and a pitch gap was 10 mm. The contact area with the ceramic honeycomb molding 3 was changed by changing the width W of the flat top of the convex portion 21 to also change a communication ratio of cells 31. The baking jig 1 having the projection shape had a large number of substantially conical projection portions 23 formed on the upper surface 2 of the ceramic body having a sheet thickness of 9 mm as shown in FIG. 6. The projection portion 23 had a height of 5 mm and a pitch gap was 10 mm. The contact area with the ceramic honeycomb molding 3 was changed by changing the diameter D of the circular top portion of the projection portion 23 to change also the communication ratio of the cells 31. The base material of the ceramic body constituting the baking jig 1 was a refractory material consisting of alumina as its main component.

The ceramic honeycomb molding 3 was acquired by extrusion molding a body that was prepared by blending talc, kaolin and alumina in a predetermined ratio as cordierite raw material powder, adding a binder, a dispersant, a lubricant and water, uniformly mixing the resulting mixture by a mixer and kneading the mixture into a honeycomb shape, by using an extrusion molding machine to which a mold having a honeycomb shape was fitted. After the resulting molding was dried by a radio frequency dryer, the molding was cut into a predetermined size. The molding had a cell wall thickness of about 0.1 mm, 600 mesh, an external diameter of 100 mm and a length of about 200 mm.

This dried molding was placed on the baking jig 1 having a corrugation shape or a projection shape according to the invention, was put into a baking furnace and was baked at 1,400° C. for 5 hours inside the atmosphere. The temperature elevation rate was 20 to 50° C. at this time within a temperature range of 100 to 500° C.

The crack occurrence ratio was examined (Examples 1 to 5) when the proportion of the cells communicating at least partially with the recess portions 22 and 24 among the cells 31 of the resulting ceramic honeycomb molding 3 was changed within the range of 30% to 70%, as tabulated in Table 1. The crack was observed by checking with eye the end face and the side surface of the baked body. As to the end face, those cracks which extended to one or more cell as shown in FIG. 7 were judged as the crack as shown in FIG. 7. As to the side surface, those cracks which were greater than 5 mm were judged as the crack as shown in FIG. 8. Baking of 500 ceramic honeycomb moldings 3 was carried out by using each of the baking jig 1 having the corrugation shape and the baking jig 1 having the projection shape, and the occurrence ratio of the cracks was calculated. Table 1 tabulates also the result.

TABLE 1

crack occurrence
ratio (%)

| | communication | corrugation | projection |
|---|---|---|---|
| | cell (%) | shape | shape |
| Comparative | 0 (conventional | 12.4 | 12.4 |
| Example 1 | flat plate) | | |
| Comparative | 10 | 7.6 | 5.2 |
| Example 2 | | | |
| Comparative | 20 | 4.8 | 3.1 |
| Example 3 | | | |
| Example 1 | 30 | 2.8 | 1.3 |
| Example 2 | 40 | 1.2 | 0.5 |
| Example 3 | 50 | 0.2 | 0.0 |
| Example 4 | 60 | 0.0 | 0.0 |
| Example 5 | 70 | 0.0 | 0.0 |

For comparison, baking of the ceramic honeycomb moldings 3 was carried out by a method similar to the case where the proportion of the communication cells was 0% to 20% and the crack occurrence ratio was examined. Table 1 tabulates the result. Incidentally, in Comparative Example 1 where the proportion of the communication cells was 0%, a flat sheet-like baking jig 1 not having concavo-convexities on the surface was used.

As is obvious from Table 1, the crack occurrence ratio was below 3% and was sufficiently low in Examples 1 to 5 where the proportion of the communication cells was 30% or more. Furthermore, in Examples 3 to 5 where the proportion of the communication cells was 50% or more, the crack occurrence ratio was 0.2% for the corrugation shape and 0% for the projection shape and could be made substantially zero.

As for the comparison of the shapes, the baking jig 1 having the corrugation shape provided a considerable effect but the crack occurrence ratio became lower in the case of the projection shape. It was assumed that in the case of the projection shape, a greater effect of preventing the occurrence of cracks could be obtained at the same proportion of the communication cells because the communication cells communicating with the outside were dispersed.

Next, the crack occurrence ratio was examined when baking of the ceramic honeycomb moldings 3 was carried out by a similar method by changing the height of the convex portion 21 within a range of 0.0 mm to 10.0 mm for the baking jig 1 (the proportion of the communication cells: 60%) for baking the ceramic honeycomb moldings 3 having the corrugation shape of Example 6. Table 2 tabulates the result.

TABLE 2

| height of convex portion (mm) | crack occurrence ratio (%) |
|---|---|
| 0.0 | 12.4 |
| 0.5 | 5.4 |
| 1.0 | 1.5 |
| 1.5 | 0.3 |
| 2.0 | 0.0 |
| 3.0 | 0.0 |
| 5.0 | 0.0 |
| 10.0 | 0.0 |

It could be understood clearly from Table 2 that the crack occurred when the height of the convex portions 21 of the baking jig 1 was 2 mm or below. It was therefore advisable to set the height of the convex portions 21 to 2.0 mm or more and by so doing, the occurrence of the cracks could be made substantially zero.

The crack occurrence ratio was examined when baking of the ceramic honeycomb moldings 3 was carried out by a similar method by changing the pitch gap of the convex portion 21 was changed within a range of 1 mm to 70 mm for the baking jig 1 (the proportion of the communication cells: 60%) for baking the ceramic honeycomb moldings 3 having the corrugation shape of Example 6. Table 3 tabulates the result.

TABLE 3

| pitch gap of | crack occurrence | |
|---|---|---|
| convex portion (mm) | ratio (%) | dent defect |
| 1 | 6.4 | ◯ |
| 2 | 3.5 | ◯ |
| 3 | 1.2 | ◯ |
| 4 | 0.3 | ◯ |
| 5 | 0.1 | ◯ |
| 10 | 0.0 | ◯ |
| 20 | 0.0 | ◯ |
| 30 | 0.0 | ◯ |
| 50 | 0.0 | X |
| 70 | 0.0 | X |

It can be understood clearly from Table 3 that when the pitch gap of the convex portions 21 of the baking jig 1 was smaller than 5 mm, dissipation of the decomposition gas was bad and the cracks were more likely to occur. When the pitch gap was greater than 30 mm, the load concentrated on the convex portions 21 and dents occurred on the convex portions 21 with which the ceramic honeycomb molding 3 came into contact. Therefore, It was therefore advisable to set the pitch gap of the convex portions 21 to the range of 5 mm to 30 mm.

The present invention provides a baking jig that is optimal for baking ceramic honeycomb moldings, can smoothly diffuse the decomposition gas occurring inside a honeycomb structure during baking and can prevent the occurrence of cracks. Consequently, the invention can produce, with high productivity high, quality ceramic honeycomb moldings.

While the invention has been described by reference to specific embodiments chosen for purposes of illustration, it should be apparent that numerous modifications could be made thereto, by those skilled in the art, without departing from the basic concept and scope of the invention.

1. A jig for holding and baking a ceramic honeycomb molding having a large number of cells juxtaposed with one another in an axial direction, wherein a surface coming into contact with said ceramic honeycomb molding has a concavo-convex shape, one of the end faces of said ceramic honeycomb molding is supported by a large number of convex portions of said surface, recess portions formed between said large number of convex portions form ventilation passages communicating with outside, and at least 30% of cells among cells of said ceramic honeycomb molding opening to said one end face communicate with said ventilation passages.

2. A jig for baking a ceramic honeycomb molding as defined in claim 1, wherein 50% to 70% of said cells of said ceramic honeycomb molding opening to said one end face communicate with said ventilation passages.

3. A jig for baking a ceramic honeycomb molding as defined in claim 1, wherein said surface has a corrugation shape.

4. A jig for baking a ceramic honeycomb molding as defined in claim 1, wherein said surface has a shape having a large number of projection portions.

5. A jig for baking a ceramic honeycomb molding as defined in claim 1, wherein the height of said convex portions is 2 mm or more.

6. A jig for baking a ceramic honeycomb molding as defined in claim 1, wherein a pitch gap of said convex portions is 5 to 30 mm.
